(19) United States
(12) Patent Application Publication
(10) Pub. No.: US 2013/0242297 A1
(43) Pub. Date: Sep. 19, 2013

(54) SUBSTRATE FOR OPTICAL SENSING BY SURFACE ENHANCED RAMAN SPECTROSCOPY (SERS) AND METHODS FOR FORMING THE SAME

(71) Applicants: Praveen Thoniyot, Singapore (SG); Nagamani Praveen, Singapore (SG); Malini Olivo, Singapore (SG)

(72) Inventors: Praveen Thoniyot, Singapore (SG); Nagamani Praveen, Singapore (SG); Malini Olivo, Singapore (SG)

(73) Assignees: SINGAPORE HEALTH SERVICES PTE LTD, Singapore (SG); AGENCY FOR SCIENCE, TECHNOLOGY AND RESEARCH, Singapore (SG)

(21) Appl. No.: 13/818,193

(22) PCT Filed: Aug. 23, 2011
(86) PCT No.: PCT/SG11/00288

§ 371 Date: May 14, 2013

(30) Foreign Application Priority Data
Aug. 24, 2010 (SG) 201006165-3

(51) Int. Cl. G01J 3/02

(52) U.S. Cl. CPC G01J 3/0267
USPC 356/244; 29/428

(57) ABSTRACT

Various embodiments relate to a substrate for optical sensing by Surface Enhanced Raman Spectroscopy (SERS). The substrate comprises a support, a first layer consisting of a plurality of metal nanoparticles attached to the surface of the support, and a second layer consisting of a plurality of metal nanoparticles attached to the surface of the metal nanoparticles of the first layer, wherein the mean diameter of the metal nanoparticles of the first layer is greater than the mean diameter of the metal nanoparticles of the second layer. Various embodiments also refer to methods for forming the substrate. In a further aspect, various embodiments refer to a biosensor comprising the inventive substrate for the detection of an analyte in a sample by SERS, a method for the detection of an analyte in a sample by SERS using the biosensor, and use of the biosensor in SERS detection methods.

### CROSS-REFERENCE TO RELATED APPLICATION

This application makes reference to and claims the benefit of priority of an application for “Novel Nanomaterial Architectures As Cost Effective And Highly Reproducible Substrates For Optical Sensing In Surface Enhanced Raman Spectroscopy (SERS) Platform” filed on Aug. 24, 2010 with the Intellectual Property Office of Singapore, and there duly assigned serial number 201006165-3. The content of said application filed on Aug. 24, 2010 is incorporated herein by reference in its entirety for all purposes.

### TECHNICAL FIELD

The invention is directed to a substrate for optical sensing by surface enhanced Raman spectroscopy (SERS). The invention also relates to methods for forming the substrate. In a further aspect, this invention relates to a biosensor for the detection of an analyte in a sample by SERS comprising the substrate of the invention, a method for the detection of an analyte in a sample by SERS using the biosensor, and use of the biosensor for detection of an analyte by SERS.

### BACKGROUND

Vibrational spectroscopic techniques, such as infra-red (IR), normal Raman Spectroscopy and Surface Enhanced Raman Spectroscopy (SERS), have been considered for analyte detection. Of these, SERS has evolved as one of the most sensitive techniques for analyte detection due to enhancement of the Raman spectral intensity by interaction of the adsorbed SERS active analyte molecules with the surface of a metal substrate.

Two mechanisms have been widely accepted for bringing about this enhancement in Raman scattering (which can be as high as 10¹⁴ times the unenhanced signal) (Kneipp K et al., Chem. Rev., 1999, 99(10), 2957-2976). They are electromagnetic enhancement and chemical enhancement.

Electromagnetic enhancement accounts for the majority of the enhancement (factor of 10⁴ to 10⁷) and arises from the interaction between the analyte that is adsorbed or brought in close proximity to the metal surface and the surface plasmon fields excited in the metal by a laser beam (Moskovits M, J. Raman Spectro., 2005, 36(6-7), 485-496). Conduction electrons that reside on the surface of a metal exhibit lateral freedom of motion as they are constricted only by the positive charges on the ‘bulk’ metal side. When light interacts with these electrons, they oscillate collectively and this oscillation is known as surface plasmon. On a roughened surface, the oscillations are localized and perpendicular to the surface plane, generating a locally amplified electromagnetic fields responsible for the SERS effect.

The localized surface plasmons (LSP) have a resonant frequency at which the absorption and scattering of light occurs most efficiently. This frequency is dependent upon the metal and the nature of the surface (size, roughness, shape, interparticle spacing and dielectric environment) (Kelly K L et al., J. Phys. Chem. B, 2003, 107(3), 668-677). This is of importance in the fabrication of SERS substrates as one may want to manipulate the resonant frequency to be close to the excitation frequency used to ensure maximal enhancements (Haynes CL & Van Duyne R P, J. Phys. Chem. B, 2003, 107(30), 7426-7433).

Chemical enhancement is argued to contribute only in an order of 10 to 10² to the overall enhancement (Liang E J & Kiefer W, J. Raman Spectro., 1996, 27(12), 879-885). It involves electron coupling between the analyte and metal surface that changes the polarizability of the molecule and forming a surface species that act as resonant intermediates in the Raman scattering. A charge transfer mechanism between the analyte and metal has also been proposed. Due to formation of new chemical bonds via charge transfer from metal to the adsorbed analyte molecules, the polarizability of the adsorbed molecules becomes much higher than that of free molecules. Such a process may be considered similar to resonant Raman scattering that occurs when the energy of the excitation light coincides with the energy of electronic transitions. Consequently, one of or a combination of the electromagnetic and chemical effects may increase the intensity of Raman signal of the adsorbate, and the enhancement factor may be up to the level of single molecule detection.

A major application for SERS substrates is in its use as a biosensor. With an extremely small cross-sectional Raman scattering area of 10⁻²⁹ cm², Raman scattering signals are innately weak. Contrary to previously held presumptions that laser excitation frequency forms the basis for signal enhancement, density of Raman hotspots on a substrate surface is presently considered to be the main factor affecting Raman signal intensity. For SERS substrates comprising nanoparticles, for example, a Raman hotspot can exist in a gap or junction between adjacent metal nanoparticles that are in close proximity to one other. These hotspots have been identified using atomic force microscopy (AFM) characterization and SERS studies as chemisorptions site for analyte molecules. Near convergence of two nanoparticles may induce coupling of their individual transition dipoles, which consist of ballistic carriers in oscillation. Coherent interference of their electromagnetic (EM) field may lead to a red-shift in the coupled plasmon resonance, and may result in amplification of the signal intensity. Accordingly, strength of the Raman signal has been found to be proportional to the number of hotspots. By varying the density of Raman hotspots on a SERS substrate, signal enhancement of up to 14 orders in magnitude has been reported.

To achieve effective biosensing capability, the inherently large variation of Raman signals has to be ameliorated. As the SERS substrate forms a key component in SERS measurement, various groups have attempted to provide an improved SERS substrate. Generally, a good SERS substrate should be capable of producing optimal Raman signal enhancement with reliable reproducibility. However, state of the art SERS substrates often suffer from non-uniform enhancement across its surface, as existing substrate fabrication processes aim to enhance signals for single-molecule detection, and as a result, produce hotspot congregations that are highly localized. For practical applications, however, substrates with high reproducibility are more suitable as they allow consistent SERS results generation.

Reproducibility of the substrates may be achieved by attaining long-range consistency in the substrate surface morphology. State of the art methods to fabricate SERS substrate having such long-range consistency include the use of techniques such as electron-beam nanolithography. While the top-down approach of electron-beam nanolithography is capable of producing substrates having a high degree of precision, the technology is very costly and is therefore, not widely available.

In view of the above, there is a need for an improved substrate for optical sensing using SERS as well as improved methods for forming it.

### SUMMARY OF THE INVENTION

In a first aspect, the invention refers to a substrate for optical sensing by Surface Enhanced Raman Spectroscopy (SERS), the substrate comprising
a) a support;
b) a first layer consisting of a plurality of metal nanoparticles attached to the surface of the support; and
c) a second layer consisting of a plurality of metal nanoparticles attached to the surface of the metal nanoparticles of the first layer,
   wherein the mean diameter of the metal nanoparticles of the first layer is greater than the mean diameter of the metal nanoparticles of the second layer.

In a second aspect, the invention refers to a method of manufacturing a substrate according to the first aspect, the method comprising
a) providing a support;
b) attaching a plurality of metal nanoparticles to the support surface to form a first layer; and
c) attaching a plurality of metal nanoparticles to the surface of the metal nanoparticles of the first layer to form a second layer,
   wherein the mean diameter of the metal nanoparticles of the first layer is greater than the mean diameter of the metal nanoparticles of the second layer.

In a third aspect, the invention refers to a biosensor comprising a substrate according to the first aspect as a biosensor.

In a fourth aspect, the invention refers to a method for the detection of an analyte in a sample by SERS using a biosensor according to the third aspect.

In a fifth aspect, the invention refers to a use of a biosensor according to the third aspect.

### BRIEF DESCRIPTION OF THE DRAWINGS

The invention will be better understood with reference to the detailed description when considered in conjunction with the non-limiting examples and the accompanying drawings, in which:

FIG. 1 is a schematic diagram showing the general scheme of manufacturing a substrate for optical sensing by SERS according to an embodiment of the present invention. FIG. 1A shows a support 101. FIG. 1B depicts functionalization of the support 101 with linker molecules 103. The support 101 that is functionalized with the linker molecules 103 may be contacted with a plurality of metal nanoparticles 105, such that the metal nanoparticles 105 attach to the support 101 as a first layer (see FIG. 1C). The metal nanoparticles 105 may be covalently bonded to the support 101 via the linker molecules 103. The attachment of the metal nanoparticles 105 to the support 101 may take place via self-assembly. FIG. 1D shows functionalization of the metal nanoparticles 105 which are attached on the support 101 with linker molecules 107. The linker molecules 107 may or may not be same as the linker molecules 103. The support with the functionalized metal nanoparticles bound thereon may be contacted with a plurality of metal nanoparticles 109, such that the metal nanoparticles 109 attach to the surface of the metal nanoparticles 105 as a second layer, such as that shown in FIG. 1E. The attachment of the metal nanoparticles 109 to the surface of the metal nanoparticles 105 may take place via self-assembly.

FIG. 2 is a schematic diagram showing an embodiment of manufacturing a substrate for optical sensing by SERS according to the examples. FIG. 2A shows a glass plate which is used as a support. As shown in FIG. 2B, the glass plate is contacted with a piranha solution activating agent comprising 3 parts concentrated sulphuric acid (H₂SO₄) to 1 part 30% hydrogen peroxide (H₂O₂) which functionalizes the surface of the glass plate with hydroxyl groups (—OH). In FIG. 2C, the glass plate functionalized with hydroxyl groups is contacted with 1% (3-mercaptopropyl) trimethoxysilate (3-MPTMS, (H₃C—O)₃Si—(CH₂)₃SH) which converts the hydroxyl groups bound on the support to thiol groups (—SH). In FIG. 2D, the glass plate functionalized with thiol groups is contacted with a solution containing gold nanoparticles, such that the gold nanoparticles attach to the glass plate via thiol-gold linkage to form a first layer on the substrate. This particular configuration is denoted as a first comparative example “G0” in the examples. In FIG. 2E, the support comprising the first layer of gold nanoparticles is contacted with a solution of 1% 1,2-Ethanedithiol which functionalizes the surface of the gold nanoparticles with thiol groups. In FIG. 2F, the support containing the functionalized gold nanoparticles is contacted with a solution containing gold nanoparticles having a mean diameter that is smaller than the mean diameter of the gold nanoparticles attached on the support. The smaller mean diameter gold nanoparticles are attached to the surface of the larger gold nanoparticles to form a second layer on the substrate. This particular configuration is denoted as “LG0” in the examples. In FIG. 2G, a second comparative example “G1” is formed by contacting the support containing the functionalized gold nanoparticles with the same solution of gold nanoparticles such that the gold nanoparticles are bound to the surface of the gold nanoparticles to form a second layer.

FIG. 3A is a schematic diagram of (III) substrate LG0 according to an embodiment of the present invention, and structures of comparative examples (I) G0 and (II) G1. FIG. 3B is the corresponding cross-sectional view of (I) G0, (II) G1 and (III) LG0.

FIG. 4 is a transmission electron microscopy (TEM) image of 40 nm gold (Au) nanoparticles prepared based on Turkevich method.

FIG. 5 is a graph showing size distribution of 40 nm gold (Au) nanoparticles in a suspension prepared using Turkevich method.

FIG. 6 is a transmission electron microscopy (TEM) image of 5 nm gold (Au) nanoparticles in a suspension used for the fabrication of a substrate LG0 according to an embodiment of the present invention. The line bar denotes a scale of 20 nm.

FIG. 7 are environmental scanning electron microscopy (ESEM) images of substrates (A) G0, (B) G1, and (C) LG0. The line bar in the images denotes a scale of 100 nm.

FIG. 8 are absorption spectra of substrates (A) G0, (B) G1, and (C) LG0.

FIG. 9 depicts molecular structures of the three Raman dyes (A) crystal violet (CV), (B) 1,2-Bis(4-pyridyl)ethane (BPE) and (C) 2-napthalenethiol (2-NT) used to test the SERS characteristics of the substrates.

FIG. 10 shows the 1 μM crystal violet (CV) SERS spectra of substrates (A) G0, (B) G1, and (C) LG0, as well as graphs comparing (D) intensity and (E) % error variation of the CV results.

FIG. 11 shows the 10 μM 2-napthalenethiol (2-NT) SERS spectra of substrates (A) G0, (B) G1, and (C) LG0, as well as graphs comparing (D) intensity and (E) % error variation of the 2-NT results.

FIG. 12 shows the 1 mM 1,2-Bis(4-pyridyl)ethane (BPE) SERS spectra of substrates (A) G0, (B) G1, and (C) LG0, as well as graphs comparing (D) intensity and (E) % error variation of the BPE results.

### DETAILED DESCRIPTION

In a first aspect, the invention refers to a substrate for optical sensing by Surface Enhanced Raman Spectroscopy (SERS). The substrate comprises a support, a first layer consisting of a plurality of metal nanoparticles attached to the surface of the support, and a second layer consisting of a plurality of metal nanoparticles attached to the surface of the metal nanoparticles of the first layer. The mean diameter of the metal nanoparticles of the first layer is greater than the mean diameter of the metal nanoparticles of the second layer.

By using metal nanoparticles of different mean diameters to form the multilayer configuration of the SERS substrate according to various embodiments of the invention, the density of Raman hotspots on the SERS substrate may be increased. The higher density of Raman hotspots on the SERS substrate enhances the effects of surface plasmon resonance on the substrate, which may in turn improve the intensity of Raman signals generated. By adopting size control of the metal nanoparticles used to form the multilayer configuration of the SERS substrate according to various embodiments of the invention, substrate reproducibility may be improved significantly.

A substrate for optical sensing by SERS, herein also termed a SERS substrate, generally refers to a well-engineered metallic nanostructure on which analyte molecules are adsorbed for SERS acquisitions. Various embodiments of the present invention relate to a SERS substrate that provides a highly uniform and reproducible bioanalysis surface.

Generally, a SERS substrate includes a support having a roughened metal surface, in which the degree of roughness of the metal surface is sufficient to induce the SERS effect. The degree of roughness of the metal surface may result in a reproducible and uniform SERS signal, such as within about 10% error variation over a substrate area of 1 cm², for analysis of materials bound to the metal surface of the substrate.

A potential advantage of a substrate according to the present invention is that no template or lithography is involved, thus providing a simple, inexpensive and quick method to achieve a highly sensitive and spatially uniform SERS signal for biomedical applications.

The support used to form the SERS substrate may generally be formed from any material. Examples of material that can be used to form the SERS substrate include, but are not limited to, glass, ceramic and organic polymers. In some embodiments, the support is glass or ceramic. In one illustrated embodiment, the support is glass.

According to various embodiments of the invention, the metal surface on the support of the SERS substrate is obtained by attaching a plurality of metal nanoparticles to the surface of the support. A “nanoparticle” refers to a particle having a characteristic length, such as diameter, in the range of up to 100 nm. The term “metal nanoparticles” refers to a nanoparticle that comprises a SERS active metal. Examples of a SERS active metal include, but are not limited to noble metals such as silver, palladium, gold, platinum, iridium, osmium, rhodium, ruthenium, and alloys thereof, and copper.

In some embodiments, the metal nanoparticles consist of a noble metal. In one embodiment, the noble metal is gold. In some embodiments, the metal nanoparticles comprise a noble metal. For example, the metal nanoparticles may have a core-shell structure, in which the core of the metal nanoparticles may be formed from any material such as a polymer or glass, and the shell of the metal nanoparticles may be formed from a noble metal. In one specific embodiment, the metal nanoparticles are gold nanoparticles.

The metal nanoparticles may be irregular or regular in shape. In some embodiments, the metal nanoparticles are regular in shape. For example, the metal nanoparticles may have a regular shape such as a sphere, a cube or a tetrahedron. Accordingly, the nanoparticles may be nanospheres, nanocubes or nanotetrahedra.

The size of the nanoparticles may be characterized by their mean diameter. The term “diameter” as used herein refers to the maximal length of a straight line segment passing through the center of a figure and terminating at the periphery. Accordingly, the term “mean diameter” refers to an average diameter of the nanoparticles, and may be calculated by dividing the sum of the diameter of each nanoparticle by the total number of nanoparticles. Although the term “diameter” is used normally to refer to the maximal length of a line segment passing through the centre and connecting two points on the periphery of a nanosphere, it is also used herein to refer to the maximal length of a line segment passing through the centre and connecting two points on the periphery of nanoparticles having other shapes, such as a nanocube or a nanotetrahedra.

The plurality of metal nanoparticles may attach to the surface of the support to form a first layer on the SERS substrate. The term “plurality” as used herein means more than one, such as at least 2, 20, 50, 100, 1000, 10000, 100000, 1000000, 10000000 or even more. The metal nanoparticles of the first layer may have a mean diameter that is less than 200 nm, such as in the range from about 10 nm to about 100 nm, or about 10 nm to about 50 nm. In one specific embodiment, the metal nanoparticles of the first layer have a mean diameter of about 30 nm to about 60 nm, for example about 40 nm.

The plurality of metal nanoparticles attached to the surface of the support to form a first layer on the substrate may be monodisperse. The term “monodisperse” refers to nanoparticles having a substantially uniform size and shape. In some embodiments, the standard deviation of diameter distribution of the metal nanoparticles of the first layer is equal to or less than 20% of the mean diameter value, such as equal to or less than 15%, 10%, 5% or 3% of the mean diameter value. In some embodiments, the diameter of the metal nanoparticles of the first layer is essentially the same.

The metal nanoparticles may be attached to the surface of the support by means of linker molecules. The term “linker molecule” refers to a molecule having one or more functional groups that can bind or link one or more nanoparticles to the support. Generally, any functional group that can bind the metal nanoparticles to the surface of the support can be used. Examples of functional groups include, but are not limited to, a thiol group, an amine group, and a 2-diphenylphosphino group.

The functional groups on the linker molecules may allow covalent bonding of the metal nanoparticles to the surface of the support. The strong covalent bonds used to attach the metal nanoparticles to the support may prevent their dislodgement, thereby resulting in mechanical stability of the metal nanoparticles on the SERS substrate.

Examples of linker molecules that can be used for attaching the metal nanoparticles to the support, in particular a glass support, include, but are not limited to, a thiol-substituted silane, an amine-substituted silane and a diphenylphoshino-substituted silane. In illustrated embodiments, (3-Mercaptoproyl)-trimethoxysilane, aminopropyl-triethoxysilane or 2-diphenylphosphino-ethyl-triethoxysilane are used as the linker molecules when gold nanoparticles are used.

Generally, the linker molecules used for immobilizing the metal nanoparticles of the first layer on the support surface should have at least one functional group that can bind to the support and at least one functional group that can bind to the metal nanoparticles of the first layer. Preferably, these two groups are different to avoid that both couple to the support or the metal nanoparticle, respectively. Alternatively, the linker molecule may be conformationally restrained such that when at least one functional group has bound to the support, at least one other functional group is, due to the conformational restraints, not able to bind to the support.

The substrate for optical sensing by SERS according to the present invention comprises a second layer consisting of a plurality of metal nanoparticles attached to the surface of the metal nanoparticles of the first layer. The metal nanoparticles forming the second layer may be formed from a SERS active metal. In some embodiments, the metal nanoparticles forming the second layer consist of a noble metal. In some embodiments, the metal nanoparticles forming the second layer comprise a noble metal. Examples of noble metal have already been described herein. In one specific embodiment, the metal nanoparticles forming the second layer are gold nanoparticles. Although the nanoparticles forming the second layer may generally comprise the same metal as the nanoparticles forming the first layer, it is not a requirement that they are the same. Accordingly, the metal nanoparticles forming the second layer may comprise a metal different from the metal nanoparticles in the first layer.

The plurality of metal nanoparticles forming the second layer on the SERS substrate may be irregular or regular in shape. For example, the metal nanoparticles may be regular in shape, such as nanospheres, nanocubes or nanotetrahedra. In some embodiments, the metal nanoparticles of the second layer have the same shape as the metal nanoparticles of the first layer. For example, the metal nanoparticles of the first layer and the second layer may both be nanospheres. In some embodiments, the metal nanoparticles of the first layer and the second layer have different shapes. For example, the metal nanoparticles of the first layer may be nanotetrahedra and the metal nanoparticles of the second layer may be nanospheres.

The mean diameter of the metal nanoparticles of the first layer is greater than the mean diameter of the metal nanoparticles of the second layer. In various embodiments, the mean diameter of the metal nanoparticles of the first layer is substantially greater than the mean diameter of the metal nanoparticles of the second layer. “Substantially greater” as used in this context, refers to mean diameters of the nanoparticles of the first layer that are at least 20%, preferably at least 50%, more preferably at least 100% greater than those of the metal nanoparticles of the second layer. The metal nanoparticles of the second layer may have a mean diameter of about 1 nm to about 90 nm, such as about 1 nm to about 75 nm, about 1 nm to about 50 nm, about 1 nm to about 20 nm, about 1 nm to about 10 nm, about 5 nm to about 10 nm, or about 4 nm to about 6 nm. In some embodiments, the metal nanoparticles of the second layer have a mean diameter of about 1 nm to about 50 nm. In one specific embodiment, the metal nanoparticles of the second layer have a mean diameter of about 1 nm to about 20 nm, for example about 5 nm.

The plurality of metal nanoparticles attached to the surface of the metal nanoparticles of the first layer to form a second layer on the SERS substrate may be monodisperse. In some embodiments, the standard deviation of diameter distribution of the metal nanoparticles of the second layer may be equal to or less than 20% of the mean diameter value, such as within 15%, 10%, 5% or 3% of the mean diameter value. In some embodiments, the diameter of the metal nanoparticles of the second layer is essentially the same.

The ratio of the mean diameter of the metal nanoparticles of the second layer to the mean diameter of the metal nanoparticles of the first layer may be between about 1:2 to about 1:100, such as between about 1:2 to about 1:75, between about 1:2 to about 1:50, between about 1:2 to about 1:25; between about 1:2 to about 1:10, or between about 1:5 to about 1:10. In various embodiments, the ratio of the mean diameter of the metal nanoparticles of the second layer to the mean diameter of the metal nanoparticles of the first layer is between about 1:2 to about 1:40. In one specific embodiment, the ratio of the mean diameter of the metal nanoparticles of the second layer to the mean diameter of the metal nanoparticles of the first layer is about 1:8.

The metal nanoparticles of the second layer may be attached to the metal nanoparticles of the first layer by means of linker molecules. Generally, any linker molecules comprising a functional group that can bind the metal nanoparticles of the second layer to the metal nanoparticles of the first layer may be used. The functional groups on the linker molecules may allow covalent bonding of the metal nanoparticles of the second layer to the metal nanoparticles of the first layer. The linker molecules for attaching the metal nanoparticles of the second layer to the metal nanoparticles of the first layer may or may not be the same as the linker molecules for attaching the metal nanoparticles of the first layer to the support. However, generally the linker molecules for attaching the metal nanoparticles of the second layer to the metal nanoparticles of the first layer are not the same as the linker molecules for attaching the metal nanoparticles of the first layer to the support, as linkage to the support usually requires different functionalities. Examples of the linker molecules that may be used for attaching the second layer nanoparticles to the first layer nanoparticles include, but are not limited to, a dithiol, a diamine and a bis(2-diphenylphosphino) compound

In illustrated embodiments, 1,2-ethanedithiol or 1,2-ethanediamine are used as the linker molecules when gold nanoparticles are used as the metal nanoparticles for both the first layer and the second layer.

The SERS substrate of the present invention may further comprise a third layer or a fourth layer consisting of a plurality of metal nanoparticles attached respectively to the surface of the metal nanoparticles of the second layer and the third layer. The mean diameter of the metal nanoparticles of each subsequent layer may be smaller than the mean diameter of the metal nanoparticles of the previous layer.

In a second aspect, the present invention refers to a method of manufacturing a substrate according to the first aspect. The method comprises providing a support, attaching a plurality of metal nanoparticles to the support surface to form a first layer, and attaching a plurality of metal nanoparticles to the surface of the metal nanoparticles of the first layer to form a second layer. The mean diameter of the metal nanoparticles of the first layer is greater than the mean diameter of the metal nanoparticles of the second layer.

The method of manufacturing a substrate according to the present invention may further comprise the step of activating the support surface by contacting with an activating agent, prior to attaching the plurality of metal nanoparticles to the support surface to form the first layer. The terms “contacting” or “incubating” are used interchangeably herein and refer generally to providing access of one component, reagent, analyte or sample to another. For example, in this instance, contacting can involve incubating the support in a solution comprising an activating agent. The activating agent may be used to remove physical impurities from the support surface. Examples of activating agents include, but are not limited to, solvents such as water, ethanol, methanol, acetone and isopropyl alcohol, acids such as sulphuric acid, and hydrogen peroxide. The activating agent used may depend on the support used. For example, when the support is glass, the activating agent may be an acid, a hydrogen peroxide or a combination thereof. In some embodiments, the activating agent comprises concentrated sulphuric acid (H₂SO₄) and hydrogen peroxide (H₂O₂).

The solution comprising an activating agent may also comprise another component or reagent which facilitates mixing, interaction, uptake, or other physical or chemical phenomenon advantageous to the contact between the support and the activating agent. In some embodiments, the step of activating the support surface may comprise physically stirring, mixing or sonicating the solution comprising the activating agent to facilitate contact of the activating agent with the support surface and/or to dislodge physical impurities from the support surface.

The method of manufacturing a substrate according to the present invention includes attaching a plurality of metal nanoparticles to the support surface to form a first layer. The support surface, optionally activated by an activating agent, may be functionalized with linker molecules capable of binding the metal nanoparticles of the first layer, prior to attaching the plurality of metal nanoparticles to the support surface to form the first layer. For example, the support may be incubated in a solution comprising linker molecules for a period of time that is sufficient to functionalize the support surface. The amount of time that is sufficient to functionalize the support surface may depend on the type of linker molecules used. Generally, the incubation time is about 2 hours.

The functionalized support may be contacted with the metal nanoparticles of the first layer to form said first layer. The metal nanoparticles may self-assemble on the support surface until all the binding sites on the support are occupied. In some embodiments, the metal nanoparticles are covalently bonded to the support surface. The metal nanoparticles may be present as colloidal metal nanoparticles in solution. In one specific embodiment, gold nanoparticles prepared by the Turkevich method, which involves citrate reduction of chloroauric acid, are used. To avoid that the metal nanoparticles aggregate in the solution, negatively charged metal nanoparticles may be used. In some embodiments, the negatively charged metal nanoparticles are metal nanoparticles carrying a negative charge at the nanoparticle surface.

Metal nanoparticles with a negative surface charge may be nanoparticles in which the negative charge of the metal nanoparticles is conferred by a carboxylic acid, sulfonic acid, carbolic acid or a mixture of the aforementioned acids which is immobilized at the surface of the metal nanoparticles. For example, the carboxylic acid may be, but is not limited to citric acid, lactic acid, acetic acid, formic acid, oxalic acid, uric acid, pyrenedodecanoic acid, mercaptosuccinic acid, aspartic acid, to name only a few. In one specific embodiment, citric acid is used to form negatively charged gold nanoparticles comprising a surface layer of citrate ions.

The method of manufacturing a substrate further comprises attaching a plurality of metal nanoparticles to the surface of the metal nanoparticles of the first layer to form a second layer, wherein the mean diameter of the metal nanoparticles of the first layer is greater than the mean diameter of the metal nanoparticles of the second layer. To achieve this, the surface of the metal nanoparticles of the first layer may be functionalized with linker molecules, such as by incubating the support with the immobilized metal nanoparticles of the first layer in a solution comprising linker molecules for a period of time that is sufficient to functionalize the surface of the metal nanoparticles, prior to attaching the plurality of metal nanoparticles thereon to form the second layer. The metal nanoparticles may self-assemble on the functionalized metal particles of the first layer until all the binding sites on the metal particles are occupied.

In a third aspect, the invention refers to a biosensor comprising a substrate according to the first aspect as a biosensor. The biosensor can be configured for in vivo and/or in vitro use.

In a fourth aspect, the invention refers to a method for the detection of an analyte in a sample by SERS. The method comprises contacting the sample with the biosensor according to the third aspect.

The term “detection” as used herein refers to a method of verifying the presence of a given molecule. The detection may also be quantitative, i.e. include correlating the detected signal with the amount of analyte. The detection includes in vitro as well as in vivo detection.

The term “analyte” as used herein refers to any substance that can be detected in an assay and which may be present in a sample. The analyte may, for example, be an antigen, a protein, a polypeptide, a nucleic acid, a hapten, a carbohydrate, a lipid, a cell or any other of a wide variety of biological or non-biological molecules, complexes or combinations thereof. Generally, the analyte will be a protein, peptide, carbohydrate or lipid derived from a biological source such as bacterial, fungal, viral, plant or animal samples. Additionally, however, the analyte may also be a small organic compound such as a drug, drug-metabolite, dye or other small molecule present in the sample.

The term “sample”, as used herein, refers to an aliquot of material, frequently biological matrices, an aqueous solution or an aqueous suspension derived from biological material. Samples to be assayed for the presence of an analyte by the methods of the present invention include, for example, cells, tissues, homogenates, lysates, extracts, and purified or partially purified proteins and other biological molecules and mixtures thereof.

Non-limiting examples of samples typically used in the methods of the invention include human and animal body fluids such as whole blood, serum, plasma, cerebrospinal fluid, sputum, bronchial washing, bronchial aspirates, urine, semen, lymph fluids and various external secretions of the respiratory, intestinal and genitourinary tracts, tears, saliva, milk, white blood cells, myelomas and the like; biological fluids such as cell culture supernatants; tissue specimens which may or may not be fixed; and cell specimens which may or may not be fixed. The samples used in the methods of the present invention will vary based on the assay format and the nature of the tissues, cells, extracts or other materials, especially biological materials, to be assayed. Methods for preparing protein extracts from cells or samples are well known in the art and can be readily adapted in order to obtain a sample that is compatible with the methods of the invention. Detection in a body fluid can also be in vivo, i.e. without first collecting a sample.

The method for the detection of an analyte in a sample by SERS may include contacting the sample with one or more Raman reporters. The term “Raman reporters” refers to compounds which have a high Raman cross-section and the Raman vibrational “fingerprint” is detectably altered, for example by a shift and/or an increase in intensity, upon the binding an analyte, so as to allow detection and quantitation of the analyte. Accordingly, the compounds can also be considered to represent reporters or receptors of the analyte.

The Raman reporter compounds may bind with the analyte molecules and may be stably adsorbed at a surface that enhances the Raman signal from the compounds, such as a substrate according to various embodiments of the invention, by reversible electrostatic interaction, hydrophobic interaction or covalent anchoring. Ideally, the compounds have a high Raman cross-section and the capability to adsorb strongly on the surface of the metal nanoparticles so that it gives a fast and intense and non fluctuating SERS signal that is proportional to the concentration of the analyte in bulk. Accordingly, by carrying out SERS measurements on the SERS substrate, the presence and/or quantity of an analyte in a sample may be determined.

The use of such a biosensor is a further aspect of the present invention. This use can be in vivo or in vitro and may comprise contacting the biosensor with the analyte containing medium, for example a sample or body fluid, and detecting the SERS signal from the sensor. Examples of bodily fluids that may be used include, but are not limited to, plasma, serum, blood, lymph, liquor and urine.

The use of a biosensor according to various embodiments of the invention is advantageous in that the SERS-based detection methods of the invention are suitable for multiplexing, which is important in particular in the context of sensing experiments, to understand complex mechanistic pathways in biological studies and in personalized medicine. Furthermore, the use of noble metals, which are biocompatible, in metal nanoparticles according to various embodiments of the SERS substrate means that analyte detection can be carried out under physiological conditions, and the sensing components can be integrated in a minimally invasive platform, such as optical fibers or implantable devices.

The invention illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

### EXPERIMENTAL SECTION

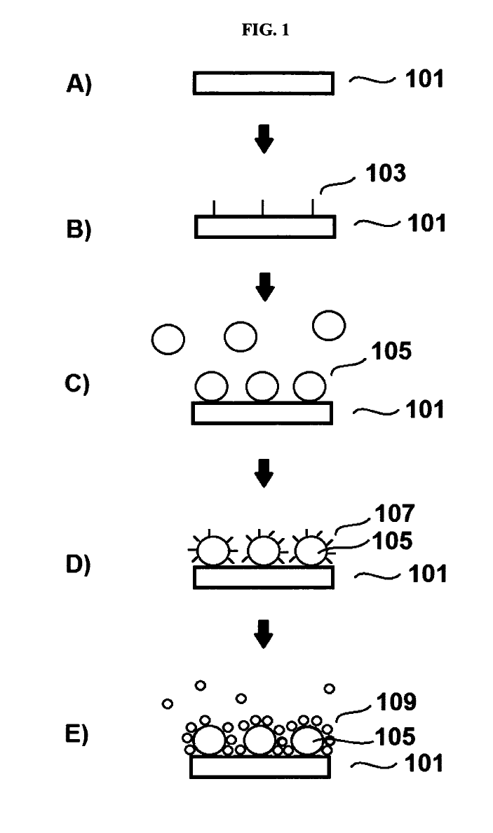

FIG. 1 is a schematic diagram showing the general scheme of manufacturing a substrate for optical sensing by SERS according to an embodiment of the present invention. FIG. 1A shows a support 101. FIG. 1B depicts functionalization of the support 101 with linker molecules 103. The support 101 that is functionalized with the linker molecules 103 may be contacted with a plurality of metal nanoparticles 105, such that the metal nanoparticles 105 attach to the support 101 as a first layer (see FIG. 1C). The metal nanoparticles 105 may be covalently bonded to the support 101 via the linker molecules 103. The attachment of the metal nanoparticles 105 to the surface of the support 101 may take place via self-assembly. FIG. 1D shows functionalization of the metal nanoparticles 105 attached on the support 101 with linker molecules 107. The linker molecules 107 may or may not be same as the linker molecules 103. The support with the functionalized metal nanoparticles bound thereon may be contacted with a plurality of metal nanoparticles 109, such that the metal nanoparticles 109 attach to the surface of the metal nanoparticles 105 as a second layer, such as that shown in FIG. 1E. The attachment of the metal nanoparticles 109 to the surface of the metal nanoparticles 105 may take place via self-assembly.

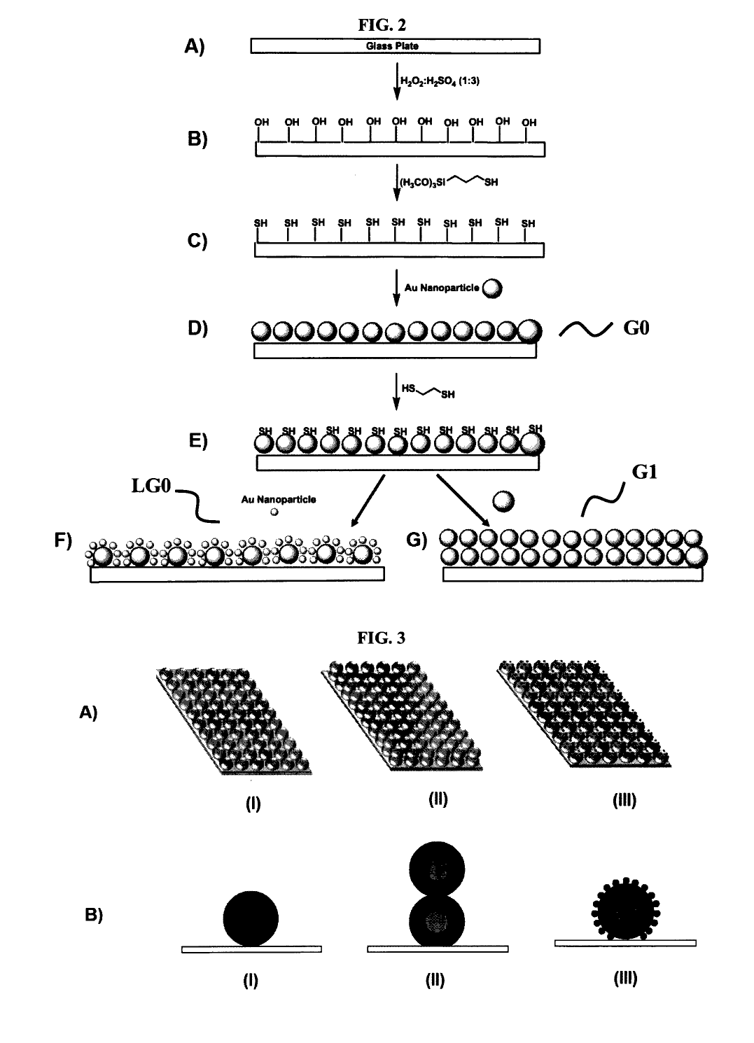

FIG. 2 is a schematic diagram showing an embodiment of manufacturing a substrate for optical sensing by SERS according to the examples. FIG. 2A shows a glass plate which is used as a support. As shown in FIG. 2B, the glass plate is contacted with a piranha solution activating agent comprising 3 parts concentrated sulphuric acid (H₂SO₄) to 1 part 30% hydrogen peroxide (H₂O₂) which functionalizes the surface of the glass plate with hydroxyl groups (—OH). In FIG. 2C, the glass plate functionalized with hydroxyl groups is contacted with 1% (3-mercaptopropyl) trimethoxysilate (3-MPTMS, (H₃C—O)₃Si—(CH₂)₃SH) which converts the hydroxyl groups bound on the support to thiol groups (—SH). In FIG. 2D, the glass plate functionalized with thiol groups is contacted with a solution containing gold nanoparticles, such that the gold nanoparticles attach to the glass plate via thiol-gold linkage to form a first layer on the substrate. This particular configuration is denoted as comparative example “G0” in the examples. In FIG. 2E, the support comprising the first layer of gold nanoparticles is contacted with a solution of 1% 1,2-Ethanedithiol which functionalizes the surface of the gold nanoparticles with thiol groups. In FIG. 2F, the support containing the functionalized gold nanoparticles is contacted with a solution containing gold nanoparticles having a mean diameter that is smaller than the mean diameter of the gold nanoparticles attached on the support. The smaller mean diameter gold nanoparticles are attached to the surface of the larger gold nanoparticles to form a second layer on the substrate. This particular configuration is denoted as “LG0” in the examples. In FIG. 2G, a second comparative example “G1” is formed by contacting the support containing the functionalized gold nanoparticles with the same solution of gold nanoparticles such that the gold nanoparticles are bound to the surface of the gold nanoparticles to form a second layer.

FIG. 3A is a schematic diagram of (III) substrate LG0 according to an embodiment of the present invention, and structures of comparative examples (I) G0 and (II) G1. FIG. 3B is the corresponding cross-sectional view of (I) G0, (II) G1 and (III) LG0.

### Example 1

### Reagent

Glass microscope slides from Marienfeld were used as the substrate for G0, G1 and LG0. Gold (III) chloride hydrate (99.999%), 5 nm colloidal gold, (3-Mercaptopropyl) trimethoxysilane (MPTMS, 95%), Raman dye Crystal Violet (CV), 2-Napthalenethiol (2-NT, 99%) and 1,2-Bis(4-pyridyl)ethane were obtained from Sigma-Aldrich. Sodium citrate dihydrate (≧99%) was obtained from SAFC. 1,2-Ethanedithiol (ET, ≧98.0%) was obtained from Fluka. Hexane, ethanol (both analytical grade), hydrochloric acid (HCl) (37%), nitric acid (HNO₃) (65%), sulphuric acid (H₂SO₄) (95 to 97%) were purchased from Merck and used as received. Water (H₂O) used was purified using an Elga Purelab Ultra distillation system to provide a resistivity of 18.2 MΩ-cm at temperature 26° C.

Aqua regia is a mixture containing 25% concentrated nitric acid in concentrated hydrochloric acid. Piranha solution is a mixture made up from 3 parts concentrated sulphuric acid and 1 part 30% hydrogen peroxide. The glassware were rinsed in aqua regia, washed thoroughly with water and ethanol, and subsequently dried prior to use. Piranha solution was used to clean the glass plates for substrate fabrication. Aqua regia was used to wash all apparatus used in the experiment as it is very effective in removing organic contaminants.

### Example 2

### Instrumentation

Ultraviolet (UV) spectral experiments were performed using a Hitachi-2900 spectrophotometer. Transmission Electron Microscopy (TEM) measurements were performed using a JEOL 2010 transmission electron microscope. Environmental scanning electron microscope (ESEM) measurements were performed using JEOL SEM6340F. All SERS measurements were taken using the Renishaw InVia, UK.

Raman and SERS measurements were carried out in a Renishaw InVia Raman (UK) microscope system with an excitation laser at 633 nm. The laser intensity at 100% laser power that is focused on the sample after passing through the objective lens was about 6.2 mW. The Raman system is connected to a Leica microscope and laser light was coupled through a 50 by 0.75 numerical aperture (N.A) objective lens, which was used to excite the sample and also to collect the returning Raman signal. The detector to collect Raman signals was a Peltier-cooled charge coupled device (CCD). WiRE 3.0 software package (provided with the Renishaw system) was used for instrument control and data acquisition. 1800 l/mm grating was chosen for spectral measurement with a resolution of about 1 cm⁻¹. The system was calibrated with a silicon standard (520 cm⁻¹) prior to each set of measurements. The acquired SERS spectra were corrected by subtracting the fluorescence background fitted with a third-order polynomial using the provided software package (Renishaw WiRE version 3.0, Renishaw). SERS was recorded at 10 different points on the same substrate, collecting three different accumulations at each point.

### Example 3

### Synthesis of 40 nm Gold Nanoparticles

Preparation of the gold colloidal suspension includes citrate reduction of chloroauric acid, also known as the Turkevich method. Gold nanoparticles are stabilized by negatively charged citrate ions, as opposing charged nanoparticles are in a state of constant repulsion thereby preventing aggregation of the gold colloidal particles.

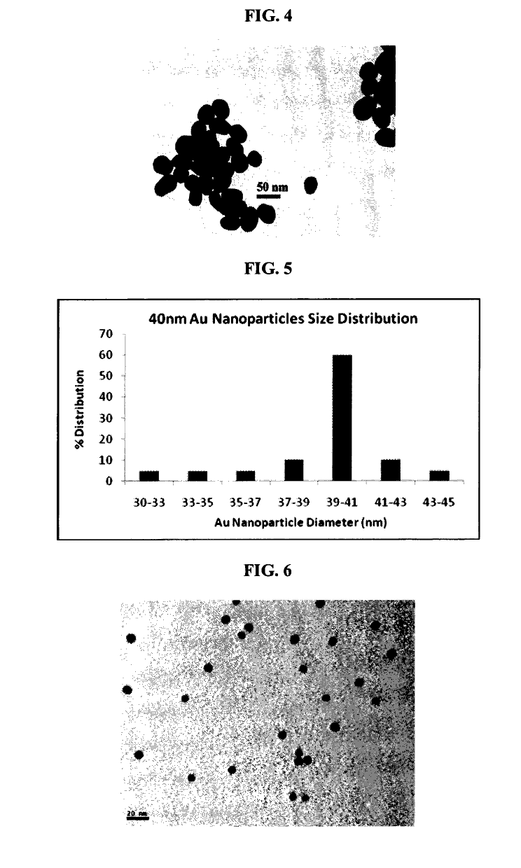

FIG. 4 is a transmission electron microscopy (TEM) image of 40 nm gold (Au) nanoparticles prepared based on Turkevich method. FIG. 5 is a graph showing size distribution of 40 nm gold (Au) nanoparticles in a suspension prepared using Turkevich method.

Clean glassware is important in the preparation of the gold colloids suspension. Prior to use, all glassware was fully immersed in Aqua regia solution (3 parts of concentrated HCl to 1 part concentrated HNO₃) for 10 minutes to remove any trace organic compounds and metal particles followed by thorough rinsing with deionized water and oven-dried at 120° C. to remove residual water.

25 mg of gold (III) chloride hydrate is dissolved in 200 ml of distilled water, in a 250-ml round-bottom flask. Using a magnetic stirrer hotplate, the solution was heated while undergoing rapid stirring until boiling. Once boiling point is reached, a separate solution containing 34.2 mg sodium citrate dehydrate in 3 ml water is added. Still under vigorous stirring condition, the mixture is kept boiling for a further 10 minutes. In a span of 30 seconds, color change is observed, evolving from light yellow to dark blue and finally violet red. Heating and stirring were discontinued and the solution is left to cool to room temperature. When not in use, the gold colloid solution is refrigerated at 3° C.

Studies have shown that gold colloid solutions are able to maintain stability for up to 1 year without significant aggregation. However, as a precautionary measure, absorbance spectrum of the colloidal solution is measured before use to ensure the absence of particle aggregation. Individual colloid size was determined from TEM characterization.

FIG. 6 is a transmission electron microscopy (TEM) image of 5 nm gold (Au) nanoparticles in a suspension used for the fabrication of a substrate LG0 according to an embodiment of the present invention.

### Example 4

### Preparation of Substrate (G0)

Microscopic glass slides were cut into approximately 1 cm² square shapes and incubated in piranha solution (3 parts concentrated sulphuric acid (H₂SO₄) to 1 part 30% hydrogen peroxide (H₂O₂)) for 2 hours. The glass slides were then washed with water and incubated in a solution of 1% (3-Mercaptopropyl) trimethoxysilate (3-MPTMS) for 2 hours to convert the hydroxyl groups on the surface of the glass to thiol groups.

The glass slides were then washed with hexane followed by several washings in ethanol. Following that, the glass slides were left overnight in a solution containing gold nanoparticles having a diameter of 40 nm, and SERS substrates (G0) were obtained. The SERS substrates were washed thoroughly with deionized water to remove any unbound gold nanoparticles. The substrates were dried using a stream of argon gas and preserved in a dry box.

### Example 5

### Preparation of Substrates (G1 and LG0)

Substrates G0 were incubated with a solution of 1% 1,2 ethanedithiol for 2 hours. Subsequently, the substrates were washed with ethanol for four times to remove excess 1,2 ethanedithiol. The substrates were then incubated in solutions containing 40 nm gold nanoparticles and 5 nm gold nanoparticles respectively for 24 hours to produce substrates G1 and LG0. The substrates were washed thoroughly with deionized water, dried using a stream of argon gas, and preserved in a dry box.

### Example 6

### Test for Reproducibility of Substrate Architecture

Substrates were incubated with a given concentration of SERS active molecule (Crystal Violet (CV), 1,2-Bis(4-pyridyl)-ethane (BPE) or naphthalene thiol (NT)) for 2 hours following their incubation in the respective gold nanoparticle solutions. SERS measurements were then taken at different random locations on the substrate. Irradiation of samples was carried out using a Helium-Neon laser with wavelength of 633 nm. A 50 times (50×) objective was used to focus the laser beam of 100% laser power onto the substrate. The reproducibility of the substrate was analyzed by the measuring the standard deviation, and consequently percentage variation, of the prominent peaks in the spectrum.

### Example 7

### ESEM Characterization of Substrate

Post fabrication, the different substrates were analyzed in terms of surface characterization using environmental scanning electron microscope (ESEM).

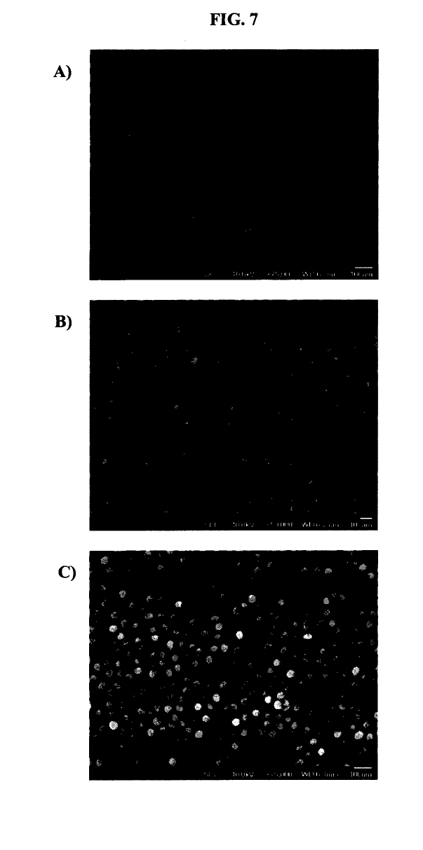

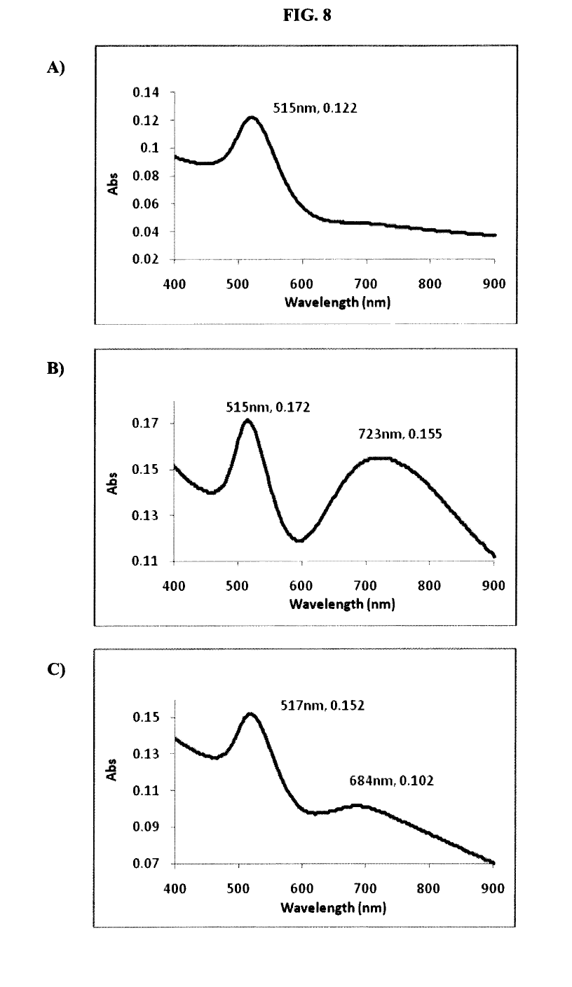

FIG. 7 are environmental scanning electron microscopy (ESEM) images of substrates (A) G0, (B) G1, and (C) LG0. ESEM image of substrate G0 reveals randomly scattered deposited gold (Au) nanoparticles. Packing density of the particles is limited by the electrostatic repulsion of negatively charged citrate ion layer surrounding each Au colloid particle. A more compact packing is possible if a non-charged layer is used for the Au coating. ESEM image of Substrate G1 at a magnification of 50 000 times, features dimer-like particles with its additional Au deposition. It appears that not all Au binding conforms to a vertical, upright attachment. The majority of the Au bindings possess orientation slanted at certain inclination. Comparison of ESEM images of substrate G0 and LG0 at a magnification of 75 000 times reveals the latter to contain particles with slightly larger diameter. Particle in substrate LG0 with its unique nodulated surface appears as a single entity due to the limited resolution of the ESEM technique in distinguishing small particles on the order of 5 nm.

### Example 8

### Ultraviolet-Visible (UV-VIS) Spectrophotometry Study of Substrates G0, G1 and LG0

UV-vis spectrophotometry characterizes Au substrates with regards to plasmonic excitation and colloidal aggregation. Calibration is done against Mercaptopropyl trimethoxysilate (MP-TMS) derivatized glass slide.

FIG. 8 depicts absorption spectra of substrates (A) G0, (B) G1, and (C) LG0. In all spectra, a pronounced band at 515 nm is observed. Presence of this peak is a result of surface plasmon excitation of the bonded Au nanoparticles. Another manifestation of the plasmonic effect can be observed through the appearance of the substrate. By mere observation, the Au substrate is seen to take on a uniformly pale shade of red and assume a darker tone with an increase in Au deposition.

### Example 9

### SERS Study of Substrate G0, G1 and LG0 using Raman Dyes

Studies of SERS substrates are often based on the use of Raman reporter compounds or dyes to understand the scattering characteristics of the substrates' surface morphology. Prepared in their suitable solvents to produce a Raman probe solution of concentrations in the range of micromolar to millimolar, SERS substrates are fully immersed in their compatible solution.

Choice of incubation period, which may range from a few minutes to a few hours, is dependent on the type of interaction occurring between the Raman reporter molecules and the metallic surface of the substrate. Interactions can be broadly classified under chemisorbed and physisorbed. In chemisorbed interactions, chemical bonds are formed between the metallic atoms of the substrate and the adsorbed Raman dye, creating a permanent attachment. Physisorption usually comprises weak electrostatic interactions between oppositely charged reporter molecules and substrate surface.

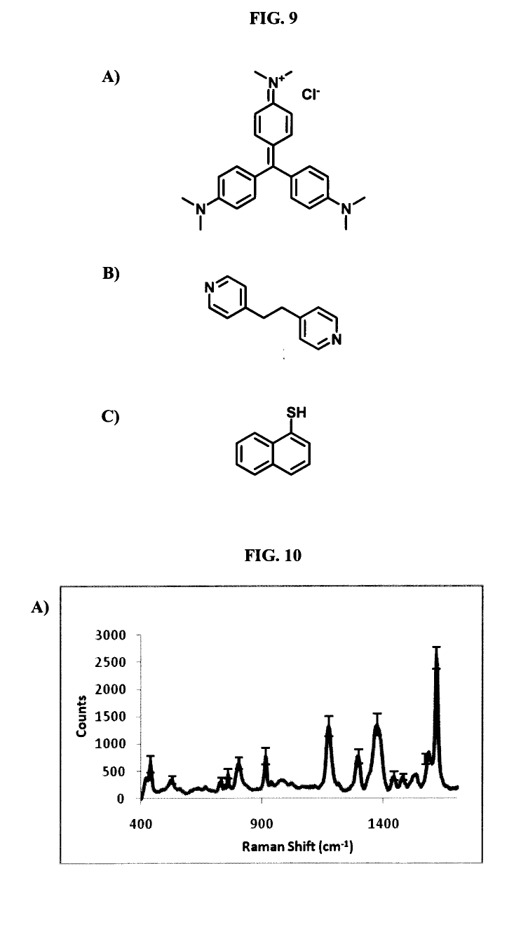

FIG. 9 depicts molecular structures of the three Raman reporter dyes (A) crystal violet (CV), (B) 1,2-Bis(4-pyridyl)ethane (BPE) and (C) 2-napthalenethiol (2-NT) used to test the Surface Enhanced Raman Spectroscopy (SERS) characteristics of the substrates G0, G1 and LG0.

For each substrate, spectra were obtained from a minimum of 10 different locations with the inter-location distance being approximately 5 μm to 10 μm apart. Following measurement of each spectrum, baseline correction is performed to eliminate the broad fluorescence band for ease of data analysis. Baseline correction done by subjecting the acquired spectra to a third-order polynomial fit available in the software package of Renishaw WiRE version 3.0.

### Example 10

### SERS Substrate Study of G0, G1 and LG0 in Crystal Violet (CV)

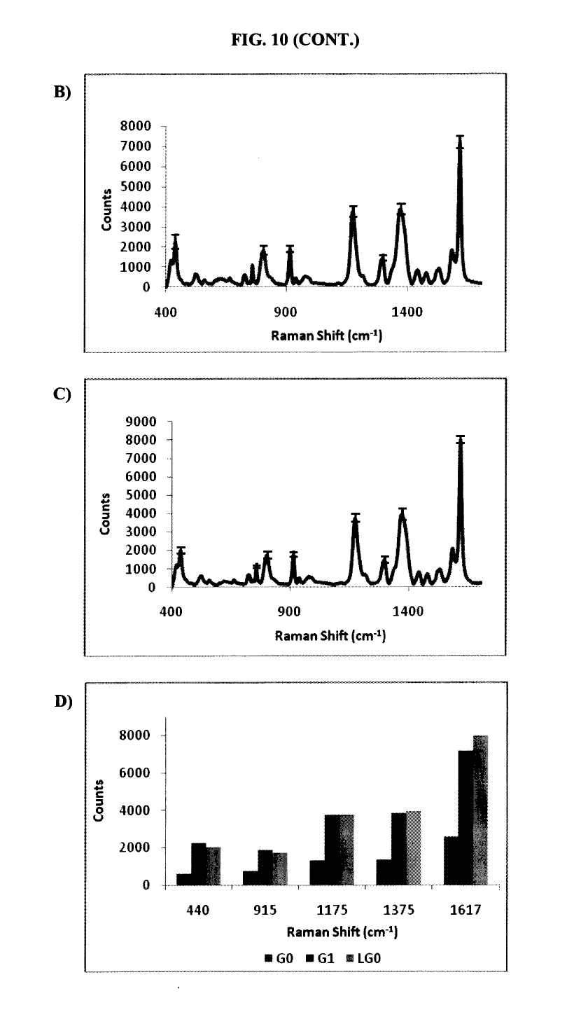

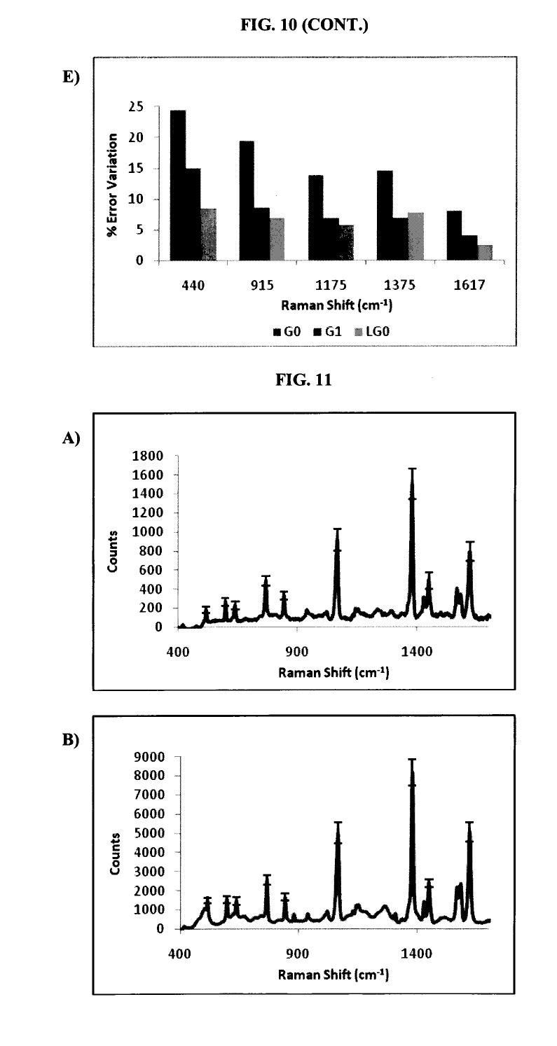

FIG. 10 shows the 1 μM crystal violet (CV) SERS spectra of substrates (A) G0, (B) G1, and (C) LG0, as well as graphs comparing (D) intensity and (E) % error variation of the CV results.

Enhancement in intensity is observed across the main peaks with additional layer of gold deposition. Comparison of substrates G1 and LG0 shows apparent enhancement for peaks at 440 cm⁻¹, 915 cm⁻¹, 1175 cm⁻¹ and 1375 cm⁻¹. A considerable increase is observed at Raman shift of 1617 cm⁻¹ where there is an 11% rise in intensity from G1 to LG0.

Observation of the error bars derived from the spectra obtained points to a general trend of decreasing error range from substrate in the order from G0 to G1 and to LG0. Results obtained show that the lowest range of error is found in substrate LG0, an indication that LG0 possesses the best surface architecture for SERS reproducibility.

### Example 11

### SERS Substrate Study of G0, G1 and LG0 in 2-Napthalenethiol (2-NT)

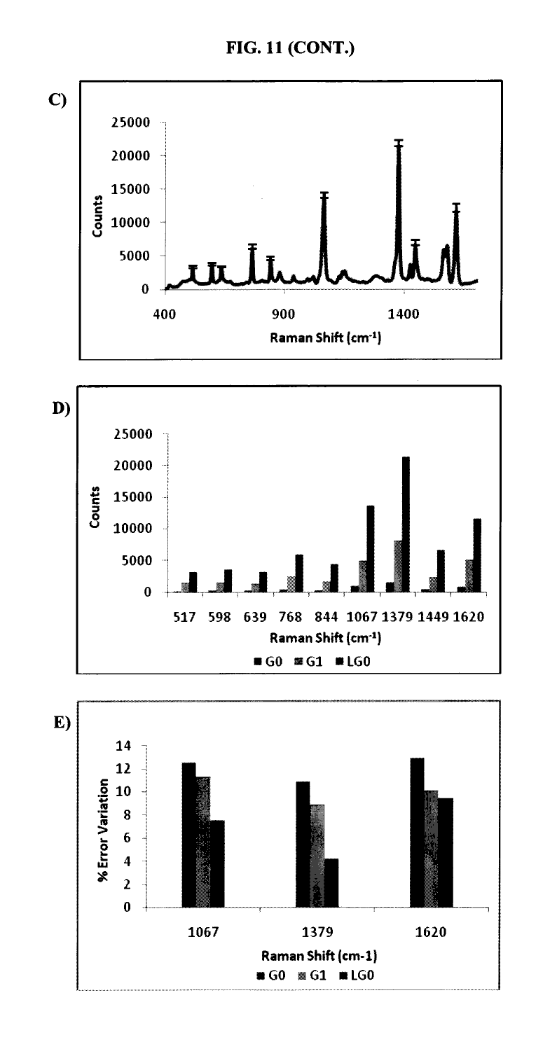

FIG. 11 shows the 10 μM 2-napthalenethiol (2-NT) SERS spectra of substrates (A) G0, (B) G1, and (C) LG0, as well as graphs comparing (D) intensity and (E) % error variation of the 2-NT results.

By analyzing all discernible peaks in the spectra, both minor and major, a consistent increasing trend in signal intensity can be observed. It can also be seen from the spectra obtained that substrate LG0 with its unique surface construction exhibits superior reproducibility.

### Example 12

### SERS Substrate Study of G0, G1 and LG0 in 1,2-Bis(4-pyridyl)ethane (BPE)

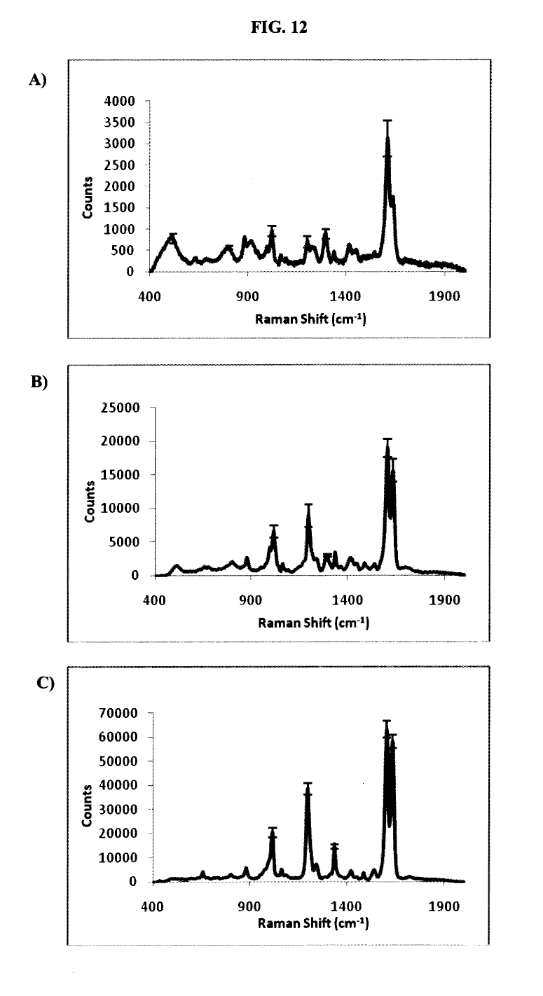

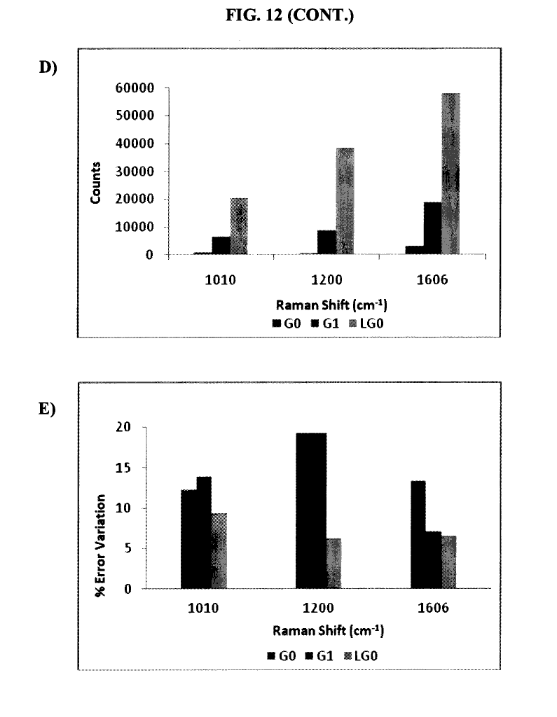

FIG. 12 shows the 1 mM 1,2-Bis(4-pyridyl)ethane (BPE) SERS spectra of substrates (A) G0, (B) G1, and (C) LG0, as well as graphs comparing (D) intensity and (E) % error variation of the BPE results.

From the major peaks located at Raman shift of 1010 cm⁻¹, 1200 cm⁻¹ and 1605 cm⁻¹, LG0 show a markedly strong intensity, with the highest at 1605 cm⁻¹ being almost thrice the equivalent value of G0. In graph (B) of FIG. 12, the standard deviation calculated is comparable for both G0 and G1. This can be explained by the highly random nature of BPE as a reporter molecule and being subjected to the influence of Brownian motion. Nevertheless as with previous CV and 2-NT studies, it can be seen that substrate LG0 is a consistent performer with invariably low % error variation and the strongest enhancement among the three substrates.

It is evident from the results of the three studies that intensity profiles of the spectra show an increasing trend with subsequent Au nanoparticles deposition. This result may be explained in terms of the availability of surface area for analyte attachment and the phenomena of Raman hotspots. Enhancement factor is calculated as a means of quantifying the effect of hotspots.

Important characteristics of a good SERS substrate are a strong signal enhancing capability and good reproducibility. As is often the case, substrates with pronounced roughness required for improving SERS efficiencies usually give rise to moderate reproducibility. This can be attributed to the difficulty in creating a surface structure with homogenous roughness in the long range, at least on a millimeter scale level. As a result, compromises have to be made in balancing SERS enhancement and reproducibility of the SERS substrates. Analyte adsorption studies using CV, 2-NT and BPE on substrate LG0 have demonstrated these two qualities. In other words, using a substrate for optical sensing by SERS according to various embodiments of the invention, it has been demonstrated that the number of Raman hotspots on the substrate surface may be increased. Furthermore, a better homogeneity in the self-assembly process of introducing a secondary deposition may also be achieved.

With the current SERS substrate enjoying a wide range of application, a substrate for optical sensing by SERS according to various embodiments of the invention can provide better competency for both qualitative and quantitative analysis. Existing SERS substrates fabricated using nanolithography and electroplating have been reported to show high enhancement and good reproducibility of similar levels. However, as such methods involve sophisticated machineries, their inherent high cost would discourage mass production of the SERS substrate. On the other hand, using a relatively simple and straightforward layer-by-layer self-assembly approach using only widely available and inexpensive chemical compounds such as that exemplified by various embodiments of the present invention, a substrate for optical sensing by SERS demonstrating high enhancement and good reproducibility may be obtained.

1. A substrate for optical sensing by Surface Enhanced Raman Spectroscopy (SERS), the substrate comprising
d) a support;
e) a first layer consisting of a plurality of metal nanoparticles attached to the surface of the support; and
f) a second layer consisting of a plurality of metal nanoparticles attached to the surface of the metal nanoparticles of the first layer,
wherein the mean diameter of the metal nanoparticles of the first layer is greater than the mean diameter of the metal nanoparticles of the second layer.

2. The substrate according to claim 1, wherein the metal nanoparticles of the first layer have a mean diameter of about 10 nm to about 100 nm.

3. The substrate according to claim 2, wherein the metal nanoparticles of the first layer have a mean diameter of about 40 nm.

4. The substrate according to any one of claims 1 to 3, wherein the standard deviation of diameter distribution of the metal nanoparticles of the first layer is equal to or less than 20% of the mean diameter value.

5. The substrate according to any one of claims 1 to 4, wherein the diameter of the metal nanoparticles of the first layer is essentially the same.

6. The substrate according to any one of claims 1 to 5, wherein the metal nanoparticles of the second layer have a mean diameter of about 1 nm to about 50 nm.

7. The substrate according to claim 6, wherein the metal nanoparticles of the second layer have a mean diameter of about 5 nm.

8. The substrate according to any one of claims 1 to 7, wherein the standard deviation of diameter distribution of the metal nanoparticles of the second layer is equal to or less than 20% of the mean diameter value.

9. The substrate according to any one of claims 1 to 8, wherein the diameter of the metal nanoparticles of the second layer is essentially the same.

10. The substrate according to any one of claims 1 to 9, wherein the ratio of the mean diameter of the metal nanoparticles of the second layer to the mean diameter of the metal nanoparticles of the first layer is between about 1:2 to about 1:40.

11. The substrate according to claim 10, wherein the ratio of the mean diameter of the metal nanoparticles of the second layer to the mean diameter of the metal nanoparticles of the first layer is about 1:8.

12. The substrate according to any one of claims 1 to 11, wherein the metal nanoparticles of the first layer comprise a noble metal.

13. The substrate according to claim 12, wherein the metal nanoparticles of the first layer consist of a noble metal.

14. The substrate according to any one of claims 1 to 13, wherein the metal nanoparticles of the second layer comprise a noble metal.

15. The substrate according to claim 14, wherein the metal nanoparticles of the second layer consist of a noble metal.

16. The substrate according to any one of claims 12 to 15, wherein the noble metal is selected from the group consisting of silver, palladium, gold, platinum, iridium, osmium, rhodium, ruthenium, and alloys thereof.

17. The substrate according to claim 16, wherein the noble metal is gold.

18. The substrate according to any one of claims 1 to 17, wherein the support is glass or ceramic.

19. The substrate according to any one of claims 1 to 18, wherein the metal nanoparticles of the first layer are attached to the support by means of linker molecules.

20. The substrate according to any one of claims 1 to 19, wherein the metal nanoparticles of the second layer are attached to the metal nanoparticles of the first layer by means of linker molecules.

21. The substrate according to claim 19 or 20, wherein the linker molecules comprise one or more functional groups selected from the group consisting of a thiol group, an amine group and a 2-diphenylphosphino group.

22. The substrate according to claim 21, wherein the linker molecule for attaching the metal nanoparticles of the first layer to the support is selected from the group consisting of a thiol-substituted silane, an amine-substituted silane and a diphenylphoshino-substituted silane.

23. The substrate according to claim 22, wherein the linker molecule is selected from the group consisting of (3-Mercaptoproyl)-trimethoxysilane, Aminopropyl-triethoxysilane and 2-diphenylphosphino-ethyl-triethoxysilane.

24. The substrate according to any one of claims 20 to 23, wherein the linker molecules for attaching the metal nanoparticles of the second layer to the surface of the metal nanoparticles of the first layer are selected from the group consisting of a dithiol, a diamine and a bis(2-diphenylphosphino) compound.

25. The substrate according to claim 24, wherein the linker molecules are selected from the group consisting of 1,2-ethanedithiol and 1,2-ethanediamine.

26. The substrate according to any one of claims 1 to 25, wherein the metal nanoparticles of the first layer are covalently bonded to the surface of the support.

27. The substrate according to any one of claims 1 to 26, wherein the metal nanoparticles of the second layer are covalently bonded to the surface of the metal nanoparticles of the first layer.

28. The substrate according to any one of claims 1 to 27, wherein the metal nanoparticles of the first layer and/or the metal nanoparticles of the second layer are nanospheres.

29. A method of manufacturing a substrate according to any one of claims 1 to 28, the method comprising
a) providing a support;
b) attaching a plurality of metal nanoparticles to the support surface to form a first layer; and
c) attaching a plurality of metal nanoparticles to the surface of the metal nanoparticles of the first layer to form a second layer,
wherein the mean diameter of the metal nanoparticles of the first layer is greater than the mean diameter of the metal nanoparticles of the second layer.

30. The method according to claim 29, wherein the method further comprises the step of activating the support surface by contacting with an activating agent prior to step (b).

31. The method of claim 30, wherein the support is glass and the activating agent is an acid, hydrogen peroxide or a mixture thereof.

32. The method according to any one of claims 29 to 31, wherein step (b) comprises functionalizing the support with linker molecules capable of binding the metal nanoparticles of the first layer and contacting the functionalized support with the metal nanoparticles of the first layer to form said first layer.

33. The method according to any one of claims 29 to 32, wherein step (c) comprises functionalizing the surface of the metal nanoparticles of the first layer with linker molecules capable of binding the metal nanoparticles of the second layer and contacting the functionalized metal nanoparticles of the first layer with the metal nanoparticles of the second layer to form said second layer.

34. Biosensor comprising a substrate according to any one of claims 1 to 28 as a biosensor.

35. Method for the detection of an analyte in a sample by SERS, comprising contacting the sample with the biosensor according to claim 34.

36. Use of the biosensor according to claim 35 for the detection of an analyte in a sample by SERS.
